(19) United States
(12) Patent Application Publication
(10) Pub. No.: US 2022/0283587 A1
(43) Pub. Date: Sep. 8, 2022

(54) CONTROLLING AN AUTONOMOUS VEHICLE USING A PROXIMITY RULE

(71) Applicant: MOTIONAL AD LLC, Boston, MA (US)

(72) Inventors: Juraj KABZAN, Singapore (SG); Boaz Cornelis FLOOR, Singapore (SG); Napat KARNACHANACHARI, Singapore (SG)

(73) Assignee: MOTIONAL AD LLC, Boston, MA (US)

(21) Appl. No.: 17/190,171

(22) Filed: Mar. 2, 2021

(51) Int. Cl. G05D 1/02

(52) U.S. Cl. CPC G05D 1/0223; G05D 1/0238; G05D 2201/0213

(57) ABSTRACT

The subject matter described in this specification is generally directed to a system and techniques for controlling an autonomous vehicle. In one example, a proximity rule is received by a control circuit. A reference trajectory is received from the planning circuit by a control circuit, where the reference trajectory is determined by the planning circuit based on the proximity rule. The control circuit receives the proximity rule and determines a predicted trajectory based on the reference trajectory and the proximity rule. The autonomous vehicle is then navigated according to the predicted trajectory.

### FIELD

This description relates to systems and techniques for controlling an autonomous vehicle using a proximity rule, e.g., using the proximity rule as part of combined model predictive control of the autonomous vehicle.

### BACKGROUND

Autonomous vehicles can be used to transport people and/or cargo (e.g., packages, objects, or other items) from one location to another. For example, an autonomous vehicle can navigate to the location of a person, wait for the person to board the autonomous vehicle, and navigate to a specified destination (e.g., a location selected by the person). To navigate in the environment, these autonomous vehicles are equipped with various types of sensors to detect objects in the surroundings.

### SUMMARY

The subject matter described in this specification is directed to systems and techniques for controlling an autonomous vehicle using a proximity rule in a combined model predictive controller (MPC). Generally, the system is configured to facilitate optimizing autonomous vehicle operation for both clearance and speed.

In particular, an example technique includes: while an autonomous vehicle is operating in an autonomous mode: receiving, using a planning circuit, a proximity rule; receiving from the planning circuit, using a control circuit, a reference trajectory, where the reference trajectory is determined by the planning circuit based on the proximity rule; receiving, using the control circuit, the proximity rule; determining, using the control circuit, a predicted trajectory based on the reference trajectory and the proximity rule; and navigating, using the control circuit, the autonomous vehicle according to the predicted trajectory.

These and other aspects, features, and implementations can be expressed as methods, apparatuses, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 shows an example of an autonomous vehicle having autonomous capability.

FIG. 2 illustrates an example “cloud” computing environment.

FIG. 3 illustrates a computer system.

FIG. 4 shows an example architecture for an autonomous vehicle.

FIG. 5 shows an example of inputs and outputs that can be used by a perception module.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning module.

FIG. 10 shows a directed graph used in path planning.

FIG. 11 shows a block diagram of the inputs and outputs of a control module.

FIG. 12 shows a block diagram of the inputs, outputs, and components of a controller.

FIG. 13 shows a block diagram of system using combined model predictive control to control an autonomous vehicle

FIG. 14A shows a lateral clearance versus lateral speed graph used in formulating a speed constraint.

FIG. 14B shows a longitudinal speed versus longitudinal clearance graph used in formulating the speed constraint.

FIG. 15 shows an example of an autonomous vehicle navigating a roadway in an environment using a proximity rule in a combined MPC.

FIG. 16 is a flow chart of an example process for controlling an autonomous vehicle using a proximity rule in a combined MPC.

### DETAILED DESCRIPTION

In the following description, for the purposes of explanation, numerous specific details are set forth in order to provide a thorough understanding of the disclosed techniques. It will be apparent, however, that the disclosed techniques can be practiced without these specific details. In other instances, well-known structures and devices are shown in block diagram form in order to avoid unnecessarily obscuring the disclosed techniques.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as can be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. Hardware Overview
3. Autonomous Vehicle Architecture
4. Autonomous Vehicle Inputs
5. Autonomous Vehicle Planning
6. Autonomous Vehicle Control
7. Autonomous Vehicle Speed Determination
8. Controlling an Autonomous Vehicle using a Proximity Rule in a Combined MPC
9. Example Process for Controlling an Autonomous Vehicle using a Proximity Rule in a Combined MPC

### General Overview

Autonomous vehicles driving in complex environments (e.g., an urban environment) pose a great technological challenge. In order for an autonomous vehicle to navigate these environments, the vehicle determines a trajectory (sometimes referred to as a route) to a destination. Once the trajectory has been determined, a controller determines control commands (e.g., steering, throttle, and braking commands) which will result in the vehicle traveling along the trajectory.

Systems and techniques are described herein for determining control commands for an autonomous vehicle. The control commands are determined based on selecting navigational inputs (e.g., data used for navigating the vehicle) differently in a near-term time period than in a far-term time period. By selecting the navigational inputs differently in different time periods, the vehicle can optimize the fidelity of the navigational inputs (e.g., more fidelity in the near-term than in the far-term, or vice versa) and/or extend the time horizon of the navigational inputs.

### Hardware Overview

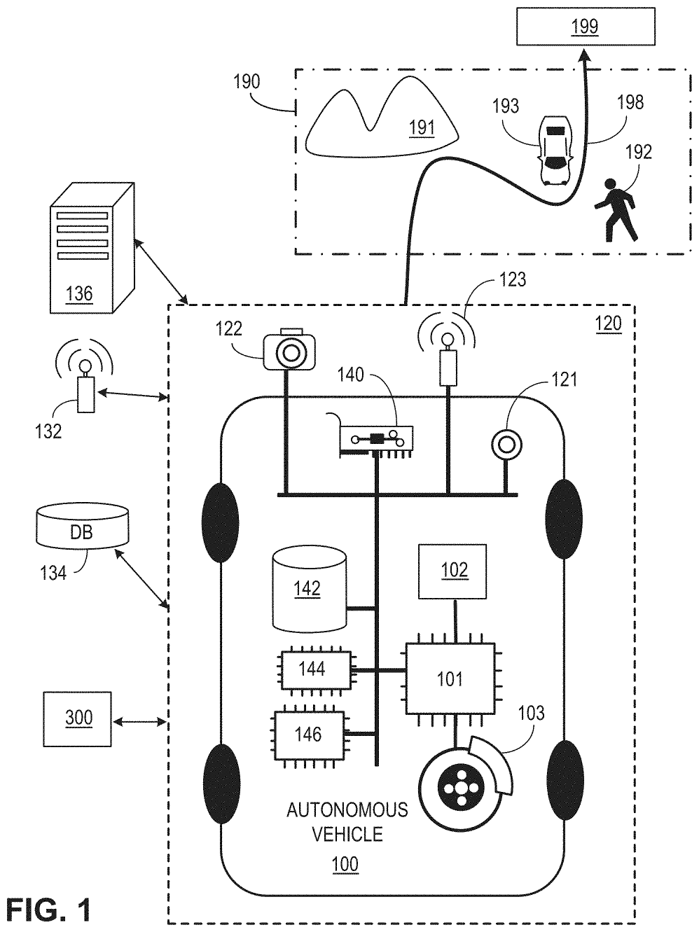

FIG. 1 shows an example of an autonomous vehicle (AV) 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to a second spatiotemporal location. In some embodiments, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In some embodiments, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and can correspond to a named thoroughfare (e.g., city street, interstate freeway, etc.) or can correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” can be a physical area not formally defined as a thoroughfare by any municipality or other governmental or administrative body.

As used herein, a “lane” is a portion of a road that can be traversed by a vehicle, and can correspond to most or all of the space between lane markings, or can correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane can be defined based on physical features of an environment, e.g., rocks and trees along a thoroughfare in a rural area.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless specified otherwise.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

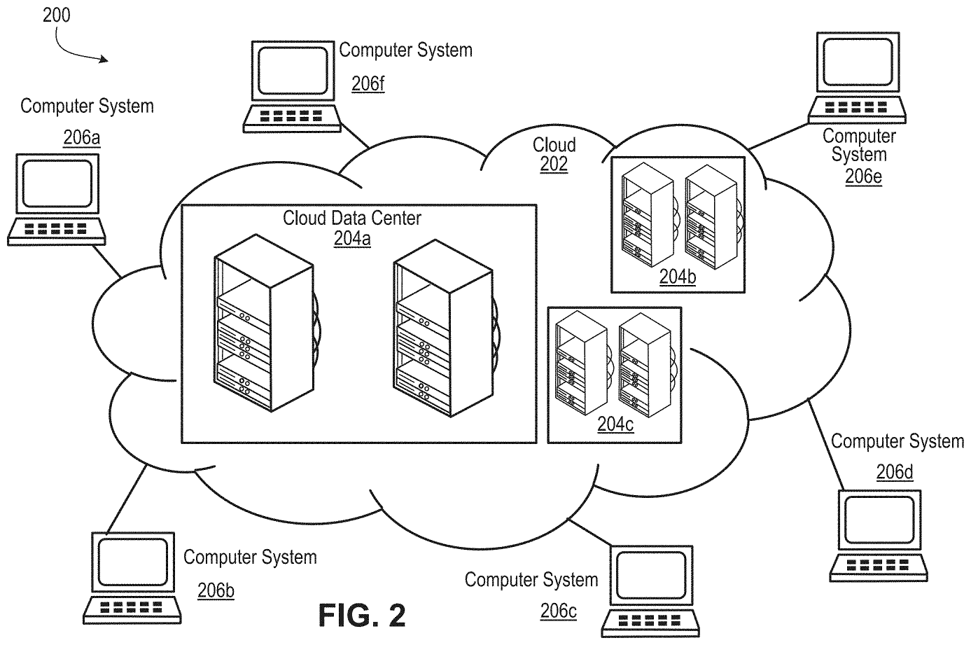

As used herein, an AV system refers to the AV along with the array of hardware, software, stored data, and data generated in real-time that supports the operation of the AV. In some embodiments, the AV system is incorporated within the AV. In some embodiments, the AV system is spread across several locations. For example, some of the software of the AV system is implemented on a cloud computing environment similar to cloud computing environment 200 described below with respect to FIG. 2.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In some embodiments, one or more of the Level 1, 2, 3, 4 and 5 vehicle systems automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding obstacles 193 (e.g., natural obstructions 191, vehicles, pedestrians 192, cyclists, and other obstacles) and obeying rules of the road (e.g., rules of operation or driving preferences).

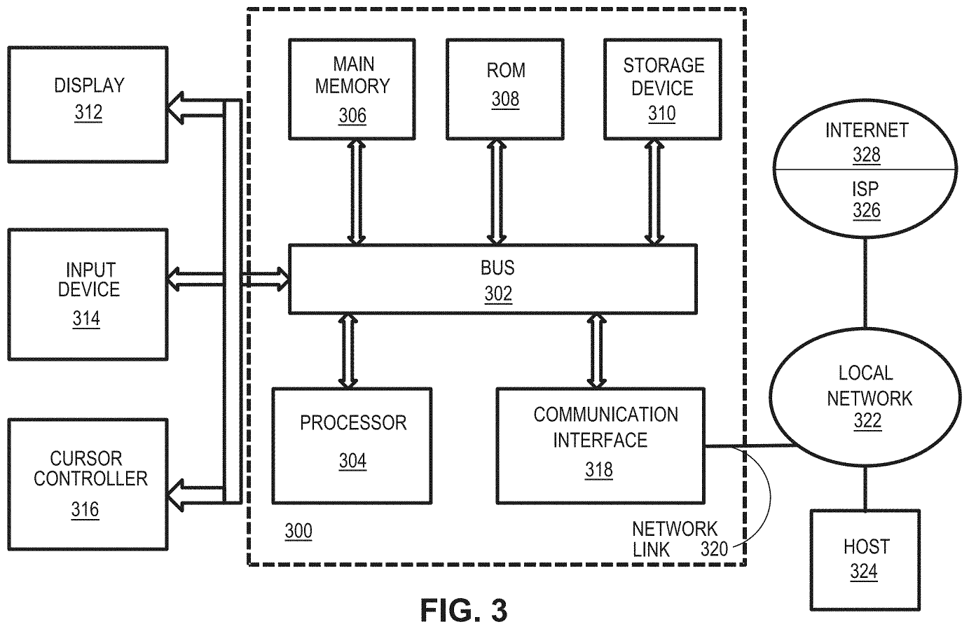

In some embodiments, the AV system 120 includes devices 101 that are instrumented to receive and act on operational commands from the computer processors 146. In some embodiments, computer processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In some embodiments, the AV system 120 includes sensors 121 for measuring or inferring properties of state or condition of the AV 100, such as the AV's position, linear and angular velocity and acceleration, and heading (e.g., an orientation of the leading end of the AV 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In some embodiments, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In some embodiments, the AV system 120 includes a data storage unit 142 and memory 144 for storing machine instructions associated with computer processors 146 or data collected by sensors 121. In some embodiments, the data storage unit 142 is similar to the ROM 308 or storage device 310 described below in relation to FIG. 3. In some embodiments, memory 144 is similar to the main memory 306 described below. In some embodiments, the data storage unit 142 and memory 144 store historical, real-time, and/or predictive information about the environment 190. In some embodiments, the stored information includes maps, driving performance, traffic congestion updates or weather conditions. In some embodiments, data relating to the environment 190 is transmitted to the AV 100 via a communications channel from a remotely located database 134.

In some embodiments, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In some embodiments, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

In some embodiments, the communication devices 140 include communication interfaces. For example, wired, wireless, WiMAX, WiFi, Bluetooth, satellite, cellular, optical, near field, infrared, or radio interfaces. The communication interfaces transmit data from a remotely located database 134 to AV system 120. In some embodiments, the remotely located database 134 is embedded in a cloud computing environment 200 as described in FIG. 2. The communication interfaces 140 transmit data collected from sensors 121 or other data related to the operation of the AV 100 to the remotely located database 134. In some embodiments, communication interfaces 140 transmit information that relates to teleoperations to the AV 100. In some embodiments, the AV 100 communicates with other remote (e.g., “cloud”) servers 136.

In some embodiments, the remotely located database 134 also stores and transmits digital data (e.g., storing data such as road and street locations). Such data is stored on the memory 144 on the AV 100, or transmitted to the AV 100 via a communications channel from the remotely located database 134.

In some embodiments, the remotely located database 134 stores and transmits historical information about driving properties (e.g., speed and acceleration profiles) of vehicles that have previously traveled along trajectory 198 at similar times of day. In one implementation, such data is stored on the memory 144 on the AV 100, or transmitted to the AV 100 via a communications channel from the remotely located database 134.

Computer processors 146 located on the AV 100 algorithmically generate control actions based on both real-time sensor data and prior information, allowing the AV system 120 to execute its autonomous driving capabilities.

In some embodiments, the AV system 120 includes computer peripherals 132 coupled to computer processors 146 for providing information and alerts to, and receiving input from, a user (e.g., an occupant or a remote user) of the AV 100. In some embodiments, peripherals 132 are similar to the display 312, input device 314, and cursor controller 316 discussed below in reference to FIG. 3. The coupling is wireless or wired. Any two or more of the interface devices can be integrated into a single device.

FIG. 2 illustrates an example “cloud” computing environment. Cloud computing is a model of service delivery for enabling convenient, on-demand network access to a shared pool of configurable computing resources (e.g., networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In some embodiments, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In some embodiments, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In some embodiments, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In some embodiments, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In some embodiments, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In some embodiments, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In some embodiments, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but can be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In some embodiments, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 can optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In some embodiments, the network 320 contains the cloud 202 or a part of the cloud 202 described above.

The computer system 300 sends messages and receives data, including program code, through the network(s), the network link 320, and the communication interface 318. In some embodiments, the computer system 300 receives code for processing. The received code is executed by the processor 304 as it is received, and/or stored in storage device 310, or other non-volatile storage for later execution.

### Autonomous Vehicle Architecture

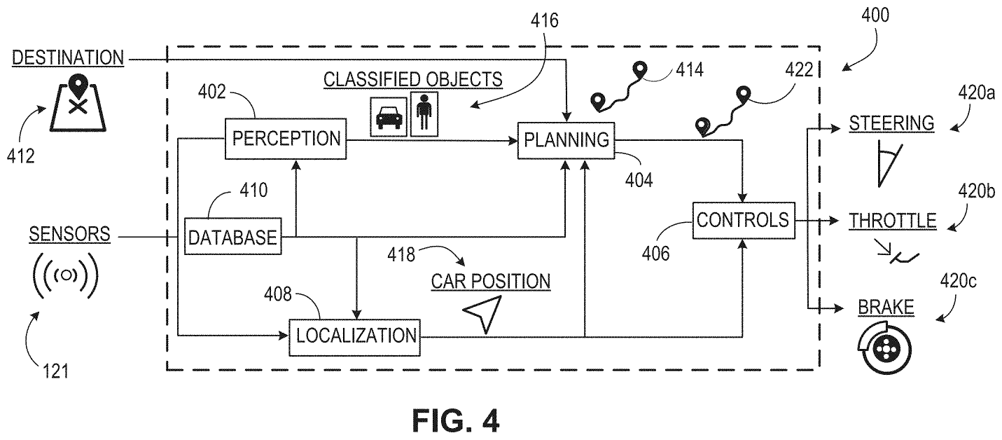

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 can be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and a proximity rule. In some embodiments, the proximity rule includes a vehicle speed constraint as a function of at least a position of the AV 100 relative to an obstacle 193 (e.g., natural obstructions 191, vehicles, pedestrians 192, cyclists, and other obstacles), where the vehicle speed constraint defines a permissible (e.g., maximum) speed of the AV 100 based on the position of the AV 100 relative to the object. In some embodiments, the vehicle speed constraint is a function of the position of the AV 100 relative to the obstacle and at least one of a type of the object or at least one property of the object (e.g., speed, perceived value (e.g., a pedestrian is more valuable than an inanimate object))

The planning module 404 then determines data representing a reference trajectory 414 (sometimes referred to as a route), based on the proximity rule, that can be traveled by the AV 100 to reach (e.g., arrive at) the destination 412. In order for the planning module 404 to determine the data representing the reference trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In some embodiments, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the reference trajectory 414 and the data representing the AV position 418. The control module 406 also receives the same proximity rule that is received by the planning module 404. Based on the reference trajectory 414 provided by the planning module 404 and the proximity rule, the control module 406 determines a predicted trajectory 422 (e.g., the control module 406 calculates a trajectory and various speed constraints based on the received proximity rule). In some embodiments, the predicted trajectory 422 includes a plurality of predictions where each prediction includes a respective predicted position of the AV 100 relative to an object along the predicted trajectory 422 and a respective predicted vehicle speed constraint to be applied to the AV 100. In some embodiments, the control module 406 determines the predicted trajectory 422 at an interval that is based on one or more operating conditions of the AV 100.

The control module then operates the control functions 420a-c (e.g., steering, throttling, braking, ignition) of the AV 100 in a manner that will cause the AV 100 to travel the predicted trajectory 422 to the destination 412. For example, if the predicted trajectory 422 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made. In some cases, the predicted trajectory 422 and the reference trajectory 414 can be the same. For example, while traversing the predicted trajectory 422, the AV 100 may not encounter any objects that cause the predicted trajectory 422 to no longer overly the reference trajectory 414. In some cases, while traversing the predicted trajectory, the AV 100 can encounter objects or otherwise need to modify the predicted trajectory 422 such that the predicted trajectory 422 and the reference trajectory 414 are not the same.

### Autonomous Vehicle Inputs

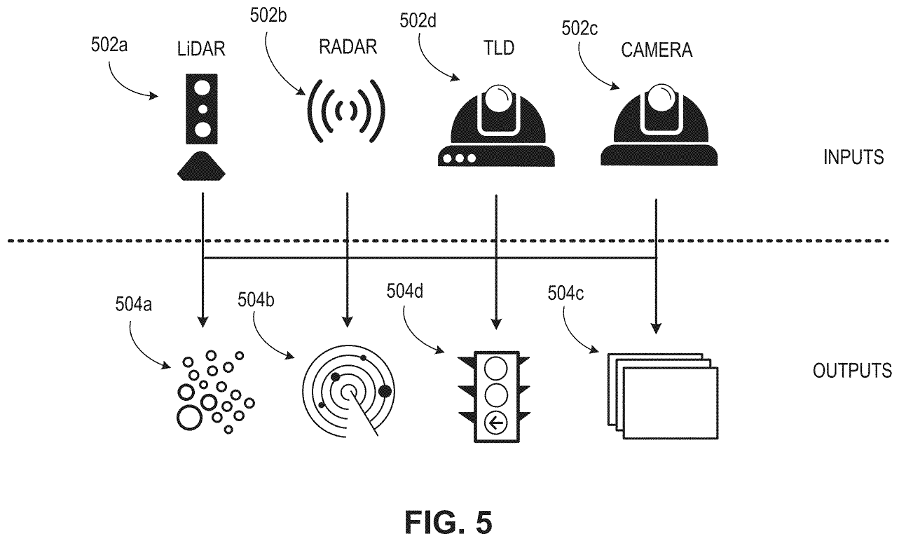

FIG. 5 shows an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system can be configured to “see” objects far, e.g., up to a kilometer or more ahead of the AV. Accordingly, the camera system can have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system can be about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

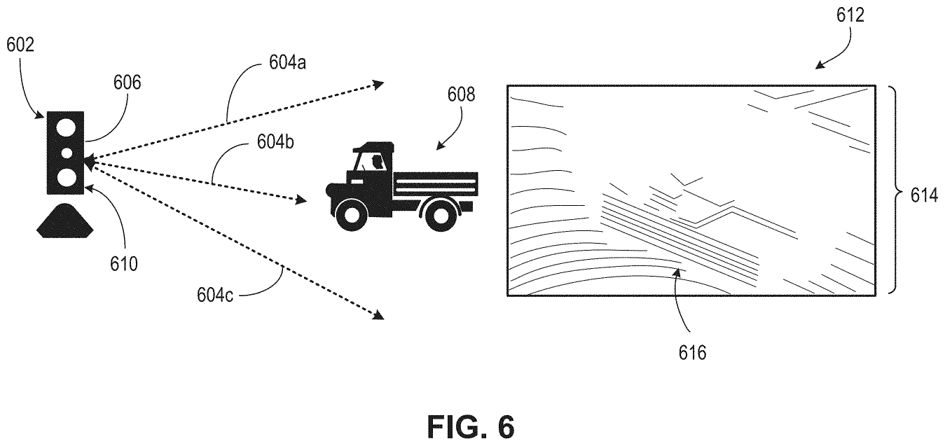

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In some embodiments, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

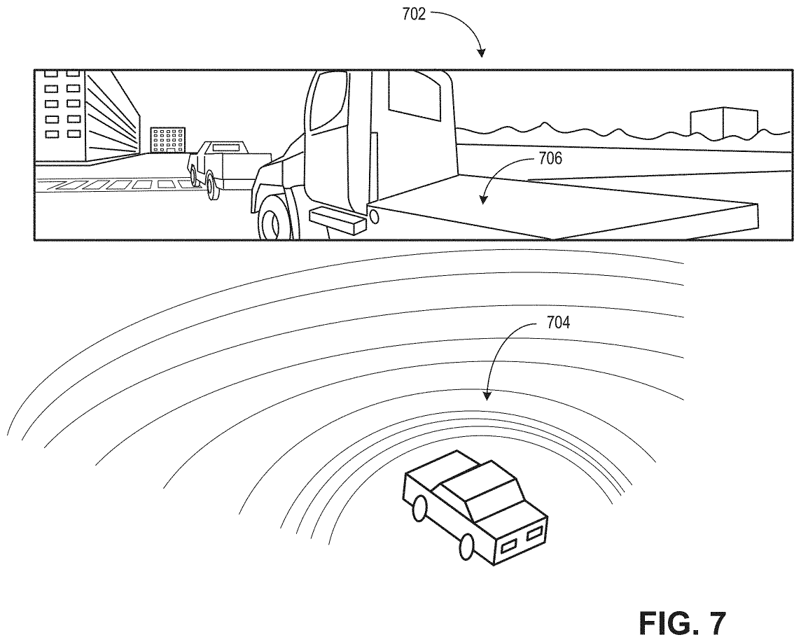

FIG. 7 shows the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

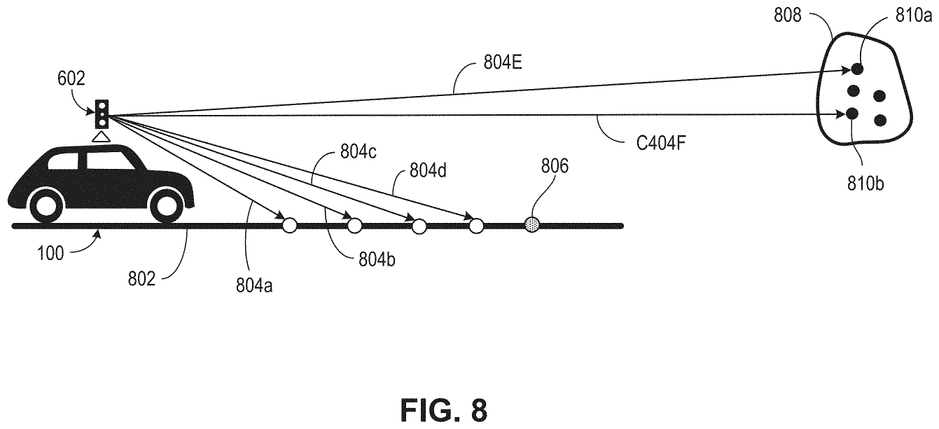

FIG. 8 shows the operation of the LiDAR system 602 in additional detail. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

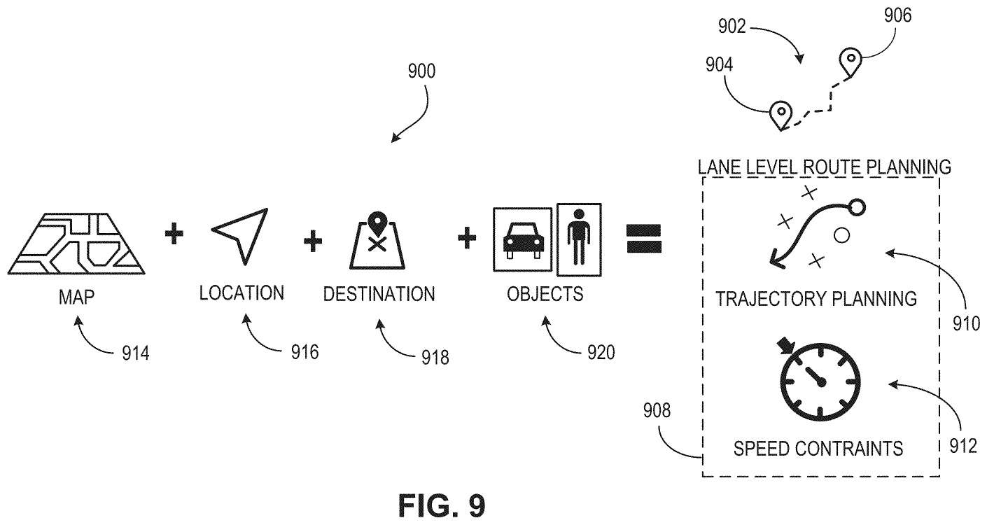

FIG. 9 shows a block diagram 900 of the relationships between inputs and outputs of a planning module 404 (e.g., as shown in FIG. 4). In general, the output of a planning module 404 is a route 902 (e.g., the reference trajectory 414) from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 can limit the AV 100 to a travel speed slower than an expected speed, e.g., a speed based on speed limit data for the segment.

In some embodiments, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

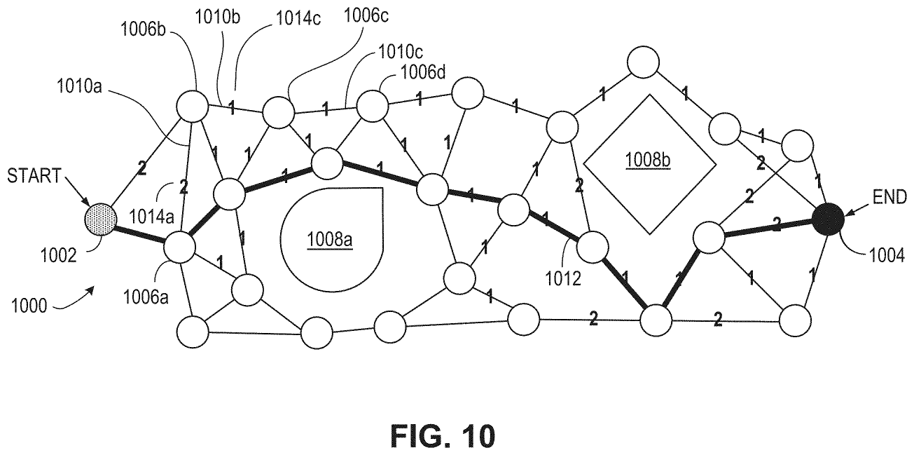

FIG. 10 shows a directed graph 1000 used in path planning, e.g., by the planning module 404 (FIG. 4). In general, a directed graph 1000 like the one shown in FIG. 10 is used to determine a path between any start point 1002 and end point 1004. In real-world terms, the distance separating the start point 1002 and end point 1004 can be relatively large (e.g, in two different metropolitan areas) or can be relatively small (e.g., two intersections abutting a city block or two lanes of a multi-lane road).

In some embodiments, the directed graph 1000 has nodes 1006a-d representing different locations between the start point 1002 and the end point 1004 that could be occupied by the AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In some embodiments, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In some embodiments, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In some embodiments, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for the AV 100 to travel between one node 1006a and the other node 1006b, e.g., without having to travel to an intermediate node before arriving at the other node 1006b. (When we refer to the AV 100 traveling between nodes, we mean that the AV 100 travels between the two physical positions represented by the respective nodes.) The edges 1010a-c are often bidirectional, in the sense that the AV 100 travels from a first node to a second node, or from the second node to the first node. In some embodiments, edges 1010a-c are unidirectional, in the sense that the AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In some embodiments, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a can be twice the associated cost 1014b of the second edge 1010b. Other factors that affect time include expected traffic, number of intersections, speed limit, etc. Another typical resource is fuel economy. Two edges 1010a-b can represent the same physical distance, but one edge 1010a can require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

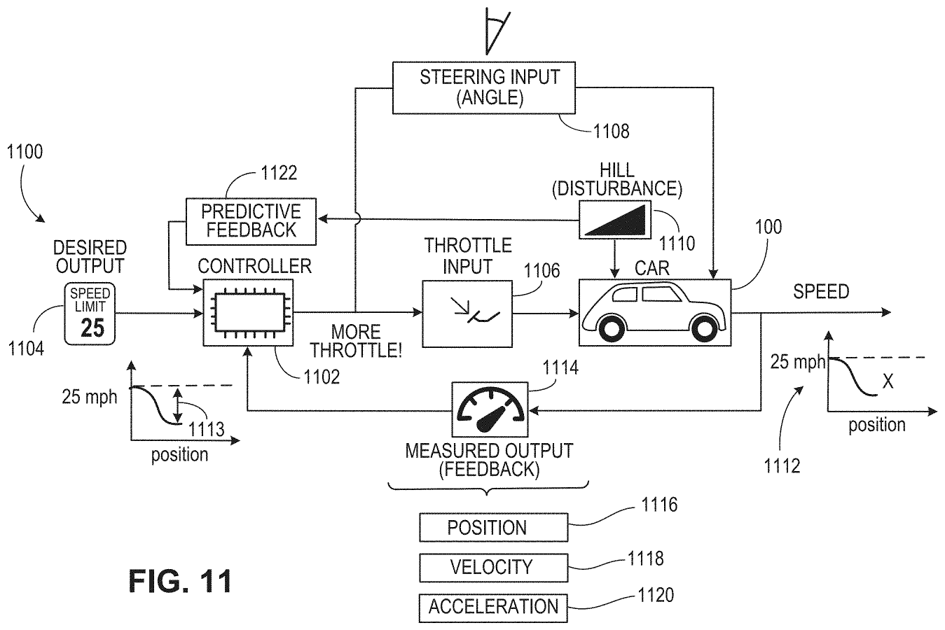

FIG. 11 shows a block diagram 1100 of the inputs and outputs of a controller 1102 (e.g., the control module 406, as shown in FIG. 4). The controller 1102 includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 310, and instructions stored in memory that carry out operations of the controller 1102 when the instructions are executed (e.g., by the one or more processors). In some embodiments, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4) or based on the predicted trajectory 422 determined by the controller 1102 and/or the control module 406 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of the AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In some embodiments, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In some embodiments, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In some embodiments, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

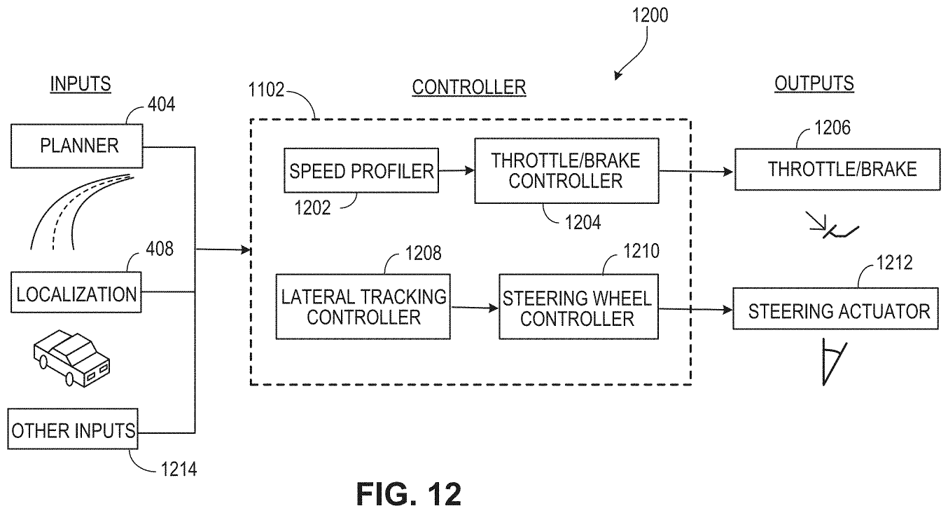

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1210 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. The planning module 404 provides information (e.g., the reference trajectory 414) to the control module 406 and/or the controller 1102, and the controller 1102 uses the received proximity rule to determine the predicted trajectory 422 that is used, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In some embodiments, the controller 1102 receives information from other inputs 1214, e.g., information received from databases, computer networks, etc.

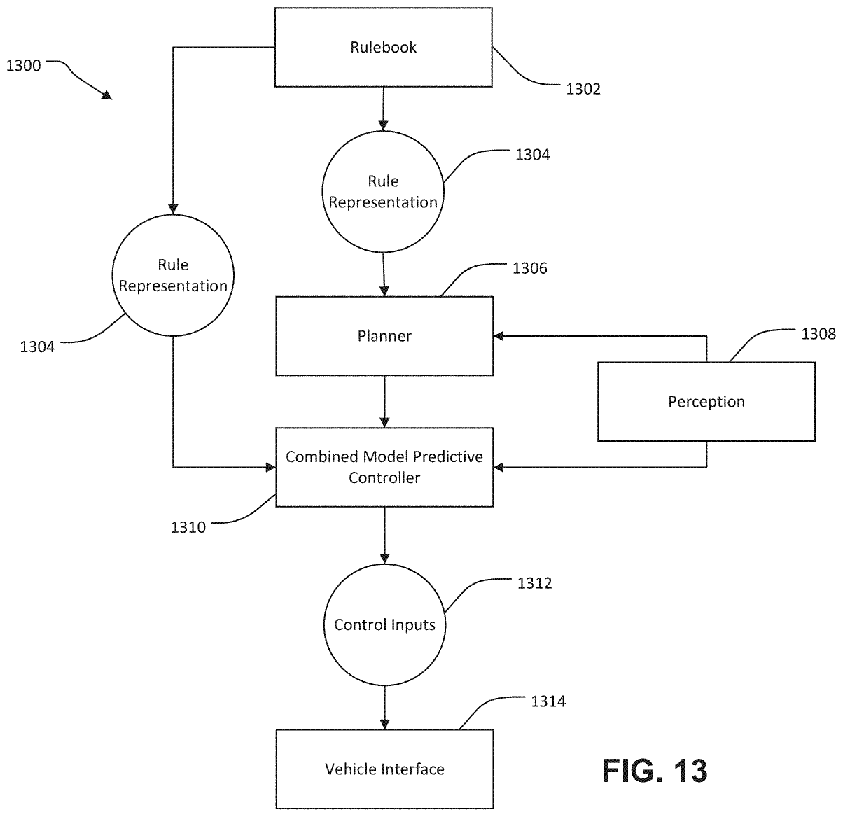

FIG. 13 shows a block diagram 1300 of the relationships between a planner 1306 (e.g., the planning module 404) configured to impose proximity speed constraints (e.g., rule representations 1304, or the proximity rule) along a planned path (e.g., the reference trajectory 414) that are to be followed by a combined MPC 1310 (e.g., the control module 406, the controller 1102) while providing control inputs 1312 to a vehicle interface 1314 of an autonomous vehicle (e.g., the AV 100).

A rulebook 1302 provides the rule representation 1304 to both of the planner 1306 and the combined MPC 1310. Additionally, perceptions 1308 (e.g., data from a perception module 402) corresponding to a surrounding environment are received by both of the planner 1306 and the combined MPC 1310. With reference to FIG. 4, the perceptions 1308 can include nearby physical objects using one or more sensors (e.g., sensors 121, as also shown in FIG. 1). These objects are classified (e.g., grouped into types such as pedestrian, bicycle, automobile, traffic sign, etc.) and a scene description including the objects that have been classified (e.g., the objects 416) is then provided to the planner 1306.

Based on the received rule representation 1304 and the received perceptions 1308, the planner 1306 generates and transmits the reference trajectory 414 to the controller, as described in reference to FIG. 4. The combined MPC 1310 receives the reference trajectory 414 and based on the rule representation 1304, the reference trajectory 414, and the received perceptions 1308, generates the predicted trajectory 422. Specifically, the same rule representation 1304 that is received by the planner 1306 is received and used by the combined MPC 1310. In some embodiments, the both of the planner 1306 and the combined MPC 1310 receive the rule representation 1304 and formulate the proximity rule explicitly as a constraint to facilitate optimizing a respective one of the reference trajectory 414 and the predicted trajectory 422 for speed and clearance of the AV 100 in relation to other objectives. As described herein, with specific reference to FIG. 4, the combined MPC 1310 generates and transmits control inputs 1312 to the vehicle interface 1314 where the control inputs 1312 are implemented to cause the AV 100 to navigate along the predicted trajectory 422.

In some embodiments, the combined MPC 1310 receives the reference trajectory 414, lateral constraints, and speed constraints (e.g., roadway speed limits, physical acceleration/deceleration limits of the vehicle, predetermined acceleration/deceleration comfort boundaries (e.g., acceleration/deceleration boundaries selected based on a level of comfort the AV 100 is intended to provide to a passenger, where acceleration/deceleration beyond the boundaries may decrease passenger comfort), limits imposed by a lead vehicle) from the planning module 404. The combined MPC 1310 then determines a curvature of the reference trajectory 414. Based on the curvature of the reference trajectory 414, the lateral constraints, and the speed constraints, the combined MPC 1310 then determines the control inputs 1312 and a set of speed commands. In some embodiments, the combined MPC 1310 determines the control inputs 1312 based in part on a lateral position of the AV 100 over time. The lateral position is determined based on multiple factors. The factors include a distance of the AV 100 to an obstacle (e.g., a stopped vehicle on a shoulder of the road), a distance of the AV 100 from the reference trajectory 414, and a threshold of lateral change (e.g., maximum rate of turning of the AV 100). In some embodiments, each of these factors is weighted based on the importance of each factor when determining the control inputs 1312.

### Autonomous Vehicle Speed Determination

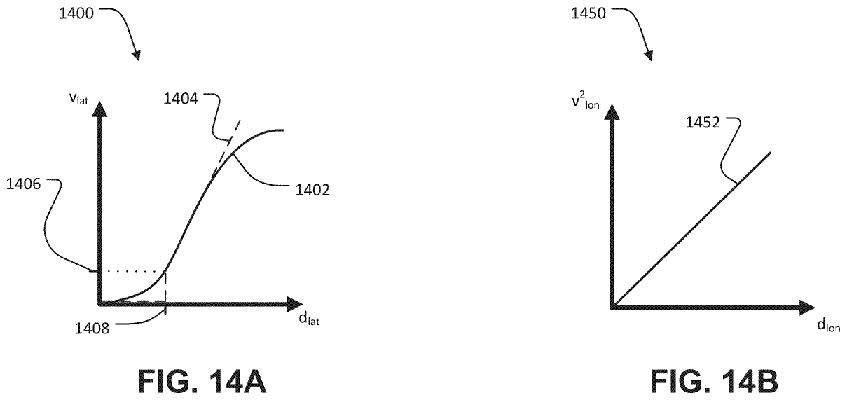

FIG. 14A shows a lateral (e.g., in a direction aligned with a widthwise dimension of a given area, a direction perpendicular to a velocity vector of the AV 100, or a direction perpendicular to one or both of the reference trajectory 414 or the predicted trajectory 422) clearance versus lateral speed graph 1400 used in determining (e.g., by the controller 1102, the control module 406, or the combined MPC 1310) at least a portion of a predicted trajectory 422 of an autonomous vehicle, e.g., the AV 100. In general, the lateral clearance versus lateral speed graph 1400 is a graphical representation of an equation used by the controller 1102 to determine a lateral speed of the AV 100 that is not to be exceeded based on a lateral distance from an obstacle 193 (e.g., natural obstructions 191, vehicles, pedestrians 192, cyclists, and other obstacles) or to determine the lateral distance from the object to be maintained by the AV 100 based on the lateral velocity of the AV 100. For example, the lateral distance separating the AV 100 from the object increases as the lateral speed increases and the lateral speed of the AV 100 decreases as the lateral distance separating the AV 100 from the object decreases.

In some embodiments, the graph 1400 includes a vertical axis representing vₗₐₜ (e.g., the lateral speed) of the AV 100, and a horizontal axis representing dₗₐₜ (e.g., the lateral distance) of the AV 100 from the object. The graph 1400 also includes a curve 1402, representing the lateral speed of the AV 100 relative to the lateral clearance of the AV 100 from the object, and a multi-segmented line 1404 representing a minimum lateral clearance of the AV 100 from the obstacle 193 for a given lateral speed of the AV 100 relative to the obstacle 193. Additionally, two constraints, a minimum avoidance lateral speed 1406 and a minimum lateral clearance 1408 are shown in the graph 1400. The minimum lateral clearance 1408 represents a minimum lateral clearance distance between the AV 100 and the obstacle 193, regardless of the lateral speed of the AV 100. The minimum avoidance lateral speed 1406 is shown positioned along the vertical axis representing vₗₐₜ, and when traced along the horizontal, dₗₐₜ, axis, intersects the curve 1402 at a point that represents a minimum avoidance lateral speed of the AV 100. As shown by graph 1400, in this embodiment, the minimum avoidance lateral speed 1406 has a non-zero value and the horizontal trace intersects the curve 1402 at the intersection of the curve 1402 and the minimum lateral clearance 1408. For example, the minimum avoidance lateral speed 1406 is predetermined to cause the AV 100 to reach the non-zero lateral speed value at the minimum lateral clearance 1408 such that the AV 100 does not move laterally closer to the object than the minimum lateral clearance 1408 and also continues to have a non-zero lateral speed so as to facilitate navigation of the AV 100 along the predicted trajectory 422.

FIG. 14B shows a longitudinal (e.g., in a direction aligned with a lengthwise dimension of a given area, a direction parallel to a velocity vector of the AV 100, or a direction parallel to one or both of the reference trajectory 414 or the predicted trajectory 422) speed versus longitudinal clearance graph 1450 used in determining, e.g., by the controller 1102, at least a portion of the predicted trajectory 422 of the autonomous vehicle, e.g., the AV 100. In general, the longitudinal clearance versus lateral speed graph 1400 is a graphical representation of an equation used by the controller 1102 to determine a longitudinal speed of the AV 100 that is not to be exceeded based on a longitudinal distance from an obstacle 193 (e.g., natural obstructions 191, vehicles, pedestrians 192, cyclists, and other obstacles) or to determine the longitudinal distance from the object to be maintained by the AV 100 based on the longitudinal velocity of the AV 100. For example, the longitudinal distance separating the AV 100 from the object increases as the longitudinal speed of the AV 100 increases and the longitudinal speed of the AV 100 decreases as the longitudinal distance separating the AV 100 from the object decreases.

In some embodiments, the graph 1450 includes a vertical axis representing v²ₗₒₙ (e.g., the square of the longitudinal speed) of the AV 100, and a horizontal axis representing dₗₒₙ (e.g., the longitudinal distance) of the AV 100 from the object. The graph 1450 also includes a line 1452 representing the square of the longitudinal speed of the AV 100 for a given longitudinal clearance distance from the object. As shown by the graph 1450, the square of the longitudinal speed of the AV 100 goes to zero as the longitudinal clearance goes to zero. In general, this is due to the assumption that the AV 100 will be traveling approximately parallel to a centerline of a road within a travel lane of the road during a given autonomous navigational session and will therefore be approaching obstacles 193 (e.g., natural obstructions 191, vehicles, pedestrians 192, cyclists, and other obstacles) occupying at least a portion of the travel lane.

With reference to FIGS. 14A and 14B, a speed constraint (v) of the AV 100 is determined by one or both of the planning module 404 or a control module/controller (e.g., the combined MPC 1310, the control module 406, the controller 1102) using the relationships between a distance between an object and the AV 100 and relative speeds of the AV 100 using equation 1 shown below.

vₚᵣₒₓ²=vₗₒₙ²+vₗₐₜ² (1)

### Controlling an Autonomous Vehicle Using a Proximity Rule in a Combined MPC

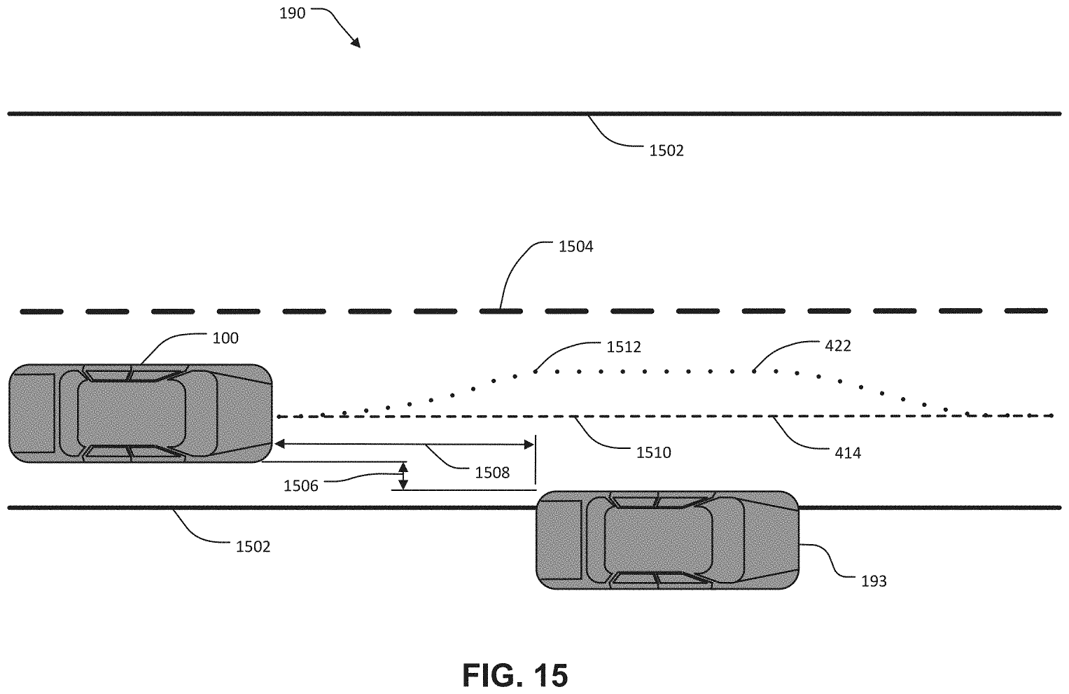

FIG. 15 shows an example of the AV 100 navigating a roadway in an environment 190 using a proximity rule and a combined MPC (e.g., the combined MPC 1310). As shown in FIG. 15, the AV 100 navigates the roadway, which includes outer lane markers 1502 and centerline 1504, based on navigational inputs which include at least one of the reference trajectory 414 and the predicted trajectory 422.

The reference trajectory 414 includes a reference path (e.g., a portion of the reference trajectory 414, which can include a position of the AV 100, a velocity of the AV 100, a rate of acceleration of the AV 100), is determined by the planning module 404 (shown in FIG. 4), and includes a plurality of reference trajectory steps 1510. As described herein, the planning module determines the reference trajectory 414 based on a proximity rule which was determined as shown in FIGS. 13 and 14A-14B. In addition to the proximity rule, the planning module 404 uses destination information, map information, position information, sensor information, and/or other data to determine the reference trajectory 414. In some embodiments, the reference trajectory 414 is a general route determined to facilitate the AV 100 navigating to reach a destination. For example, as shown in FIG. 15, the reference trajectory 414 specifies that the AV 100 is to proceed forward on the roadway approximately laterally centered between the outer lane marker 1502 and the centerline 1504, but without specifying precise steering or speed commands for the AV 100 to execute in order to proceed forward (e.g., throttle input 1106 and steering input 1108). In some embodiments, the reference trajectory 414 specifies that the AV 100 is to turn onto a different roadway, but without specifying precise steering or speed commands for the AV 100 to execute in order to perform the turn.

The predicted trajectory 422 is determined by the combined MPC 1310 (and/or the control module 406 and/or the controller 1102 (as shown in FIGS. 4 and 11)) as described in reference to FIG. 13 and includes a plurality of predicted trajectory steps 1512. More specifically, the predicted trajectory 422 includes the plurality of predicted trajectory steps 1512 each including a respective predicted position of the AV 100 relative to the obstacle 193 and a respective vehicle speed constraint. As described herein, the combined MPC 1310 receives the proximity rule (e.g., velocity constraints based at least on a distance to an object from the AV 100) and determines the predicted trajectory 422 based on the reference trajectory 414 and the proximity rule (e.g., the combined MPC 1310, in addition to the planning module 404, calculates a trajectory for the AV 100 and various constraints based on the received proximity rule). In some embodiments, the interval at which the predicted trajectory steps 1512 are determined is based on at least one of a rate of closure between the AV 100 and the obstacle 193, a predicted speed of the AV 100, a difference between the reference trajectory 414 and the predicted trajectory 422, or a shape of the obstacle 193. In some embodiments, the rate of closure between the AV 100 and the obstacle 193 depends on a velocity of the obstacle 193 relative to the AV 100.

Each of the reference trajectory and the predicted trajectory 422 for the AV 100 can also include one or more constraints for the AV 100 (e.g., lateral constraints and speed constraints). Constraints for the AV 100 are determined based on map information, sensor information, and/or other data. Lateral constraints indicate the maximum distances to the left and right that the AV 100 can safely deviate from the predicted trajectory 422 at different points in time/position along the predicted trajectory 422 as the AV 100 travels along the predicted trajectory 422. For example, lateral constraints maintain the AV 100 within a “safe” travel lane of the roadway. In an instance when the AV 100 deviates outside the predetermined lateral constraints, the AV 100 can enter a hazardous area outside of the travel lane as a result of the deviation from the predicted trajectory 422. In some examples, lane markings on the roadway (e.g., outer lane markers 1502, centerline 1504) are used in determining lateral constraints. In some examples, edges of the roadway (e.g., a lateral boundary of a road shoulder) are used in determining lateral constraints. In some examples, obstacles (e.g., obstacle 193) near or on the roadway are used in determining lateral constraints. Lane markings, edges of the roadway, and obstacles near or on the roadway can be detected by one or more sensors on the AV 100.

Speed constraints can include roadway speed limits, physical acceleration/deceleration limits of the vehicle, predetermined acceleration/deceleration comfort boundaries (e.g., acceleration/deceleration boundaries selected based on a level of comfort the AV 100 is intended to provide to a passenger, where acceleration/deceleration beyond the boundaries can decrease passenger comfort), and/or speed limits imposed by a lead vehicle.

As part of controlling the AV 100 using the proximity rule in a combined MPC, the proximity rule includes a vehicle proximity speed constraint (vₚᵣₒₓ) as a function of at least a position of the AV 100 relative to the obstacle 193 (illustrated as a vehicle in FIG. 15) that is at least partially within a predicted path of the AV 100 according to one or both of the reference trajectory 414 or the predicted trajectory 422. In some embodiments, the vehicle proximity speed constraint defines a permissible (e.g., maximum) speed of the AV 100 based on the position of the AV 100 (either present position or a future position along the predicted trajectory 422) relative to the obstacle 193. The position (e.g., either of the present position or the future position of the AV 100) of the AV 100 relative to the obstacle 193 is defined by the lateral clearance distance 1506 and the longitudinal clearance distance 1508. The vehicle proximity speed constraint can include a vehicle speed limit for the AV 100 and associated with at least a portion of the reference trajectory 414 or the predicted trajectory 422 which can vary along the reference trajectory 414 or the predicted trajectory 422 and can be based on the lateral clearance distance 1506 and the longitudinal clearance distance 1508. In some embodiments, the vehicle speed limit for the AV 100 includes at least one of a legal vehicle speed limit, a vehicle capability speed limit, or a user-defined vehicle speed limit.

The vehicle proximity speed constraint is a function of the lateral clearance (dₗₐₜ) and the longitudinal clearance (dₗₒₙ) of the AV 100 relative to the object. In some embodiments, the vehicle proximity speed constraint is additionally a function of a type of the obstacle (e.g., pedestrian, another vehicle, a road boundary) or at least one property of the obstacle 193 (e.g., speed of the obstacle 193, perceived value of the obstacle 193 (e.g., a pedestrian is more valuable than a vehicle or other object)). The longitudinal clearance and the lateral clearance can be determined based on a current location of the AV 100, or the longitudinal clearance and the longitudinal clearance can each represent clearances between the AV 100 and the obstacle at some future time (e.g., expected clearances between the obstacle 193 and one of plurality of locations along the predicted trajectory 422 or the reference trajectory 414). The vehicle proximity speed constraint represents a value that is less than a predetermined speed constraint (v) associated with a current or predicted position of the AV 100 according to the factors described above, as shown below in equation 2.

v<vₚᵣₒₓ(dₗₐₜ,dₗₒₙ)

In some embodiments, for each of the plurality of predicted trajectory steps 1512, as part of a gradient-based approach to controlling a speed and position of the AV 100, the combined MPC 1310 calculates a biasing speed constraint (cₖ^{vel,biasing}) for each individual prediction step (k) that has to be satisfied for each state of the controller (e.g., the combined MPC 1310) being optimized (xₖ) and a slack imposed on the constraint (sₖ). The biasing speed constraint as a function of the state of the combined MPC 1310 being optimized and the slack is equal to a function of the longitudinal and the lateral components of the velocities of the AV 100 relative to obstacles 193 positioned on the left of the AV 100 and the right of the AV 100. More specifically, with respect to the obstacle 193 positioned to the left of the AV 100, the speed constraint component of the AV 100 at an individual prediction step (vₖ) minus a left longitudinal speed constraint at the prediction step (v_{lon,left,k}) plus a left lateral speed constraint at the prediction step (v_{lat,left,k}) minus a slack of the speed constraint at the prediction step (sᵥ, k) comprises the longitudinal and the lateral components of the velocities of the AV 100 relative to the obstacle 193 positioned on the left of the AV 100. With respect to the obstacle 193 positioned to the right of the AV 100, the speed constraint component of the AV 100 at the individual prediction step minus a right longitudinal speed constraint at the prediction step (v_{lon,right,k}) Plus a right lateral speed constraint at the prediction step (v_{lat,right,k}) that is multiplied by the position of the AV 100 relative to the reference trajectory 414 at the prediction step (nₖ) minus a slack of the speed constraint at the prediction step (sᵥ, k) comprises the longitudinal and the lateral components of the velocities of the AV 100 relative to the obstacle 193 positioned on the right of the AV 100. These longitudinal and lateral components of the velocities of the AV 100 relative to the left and right obstacles 193 are compiled for each prediction step (∀k) at every position of the AV 100 relative to the reference trajectory 414 (ϵ{0, . . . , N}) as shown below in equation 3.

$${c}_{k}^{vel , biasing} ( {x}_{k} , {s}_{k} ) = \{ \begin{matrix}{v}_{k} - {v}_{lon , left , k} + {v}_{lat , left , k} ( {n}_{k} ) - {s}_{v} , k & \leq 0 \\ {v}_{k} - {v}_{lon , right , k} + {v}_{lat , right , k} ( {n}_{k} ) - {s}_{v} , k & \leq 0\end{matrix} ∀ k ∈ \{ 0 , … , N \} \qquad ( 3 )$$

The biasing speed constraint is a function of both the longitudinal clearance and the lateral clearance of the AV 100 from the obstacle 193 such that an increase in one or both of the lateral clearance of the AV 100 from the obstacle 193 or an increase in the longitudinal clearance of the AV 100 from the obstacle 193 yields an increase in the biasing speed constraint. Further, the biasing speed constraint is a function of both the longitudinal clearance and the lateral clearance of the AV 100 from the obstacle 193 such that decrease in one or both of the lateral clearance of the AV 100 from the obstacle 193 or a decrease in the longitudinal clearance of the AV 100 from the obstacle 193 yields a decrease in the biasing speed constraint.

Combined MPC 1310 (as shown in FIG. 13) uses determined vehicle speed proximity constraints at each of the plurality of the navigational inputs (e.g., predicted trajectory 422, lateral constraints, speed constraints, and other information (such as the AV position 418 and the AV velocity)) to determine control commands (also referred to as control functions 420a-c) (e.g., steering, throttling, braking) that will cause the AV 100 to travel along predicted trajectory 422. The navigational inputs used by combined MPC 1310 are associated with current and future points in time (e.g., current and future predicted trajectory steps 1512). For example, navigational inputs that indicate the AV 100 will be making a turn in approximately 3 seconds are used by combined MPC 1310 to determine control commands that will allow AV 100 to make the turn at that future time (e.g., the AV begins braking before the turn).

Implementing the proximity rule in a combined MPC facilitates desired operation of the AV 100 while the AV 100 is in the proximity of obstacles 193 which require deviation of operation of the AV 100 from that determined by the planning module 404. Specifically, adopting the proximity rule as part of trajectory optimization (e.g., determining the predicted trajectory 422 by the combined MPC 1310) facilitates optimizing speed and clearance relationships of the AV 100 with the surrounding environment because the gradient-based predicted trajectory 422 yields a solution for the AV 100 that results in individual step resolution (e.g., the predicted trajectory steps 1512) that is superior to the sampling-based reference trajectory 414 generated by the planning module 404.

In some embodiments, as part of controlling the AV 100 along the predicted trajectory 422, the combined MPC 1310 can receive input from one or more of the sensors associated with the AV 100 indicating a collision between the AV 100 and the obstacle 193. In response to such a determination, the combined MPC 1310 can activate an emergency collision avoidance system to cause a deviation of the AV 100 from the predicted trajectory 422, the deviation determined by the emergency collision system to reduce a likelihood of the collision occurring between the AV 100 and the obstacle 193.

### Example Process for Controlling an Autonomous Vehicle Using a Proximity Rule in a Combined MPC

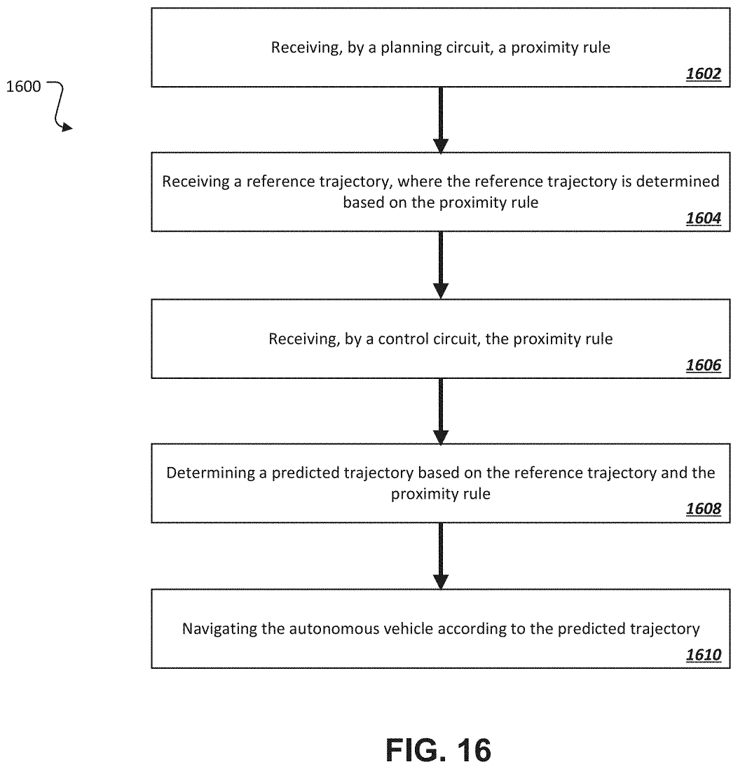

FIG. 16 is a flow chart of an example process 1600 for controlling an autonomous vehicle (e.g., AV 100) using a proximity rule. Process 1600 is described as being performed by a control circuit (e.g., the combined MPC 1310 of FIG. 13). In some embodiments, the control circuit includes microcontrollers with embedded processing circuits. In some embodiments, process 1600 will be described as being performed by a system of one or more computers located in one or more locations. For example, the AV system 120 of FIG. 1 (or portions thereof), appropriately programmed in accordance with this specification, can perform the process 1600.

At block 1602, while the autonomous vehicle is operating in autonomous mode (e.g., a fully or highly autonomous mode with automated steering, acceleration, braking, and navigation (e.g., Level 3, 4, or 5)), using a planning circuit (e.g., the planning module 404), a proximity rule (e.g., velocity constraints based on distance from the autonomous vehicle to an object) is received. In some embodiments, the proximity rule includes a vehicle speed constraint as a function of at least a position of the autonomous vehicle relative to an obstacle 193 (e.g., natural obstructions 191, vehicles, pedestrians 192, cyclists, and other obstacles). In such embodiments, the vehicle speed constraint defines a permissible speed of the autonomous vehicle based on the position of the autonomous vehicle relative to the obstacle. In some embodiments, the vehicle speed constraint is a function of the position of the autonomous vehicle relative to the obstacle and at least one of a type of the obstacle or at least one property of the obstacle.

At block 1604, a control circuit (e.g., the combined MPC 1310) receives a reference trajectory (e.g., reference trajectory 414) from the planning circuit, where the reference trajectory is determined by the planning circuit based on the proximity rule. In some embodiments, the reference trajectory includes a reference path (e.g., the position portion of the reference trajectory, which can include position, velocity, acceleration, etc.) of the autonomous vehicle and at least one vehicle speed constraint of the autonomous vehicle associated with at least one portion of the reference path. In such embodiments, the reference path of the autonomous vehicle can include a reference lateral clearance of the autonomous vehicle from the obstacle and a reference longitudinal clearance of the autonomous vehicle from the obstacle for the at least one portion of the reference path.

In some embodiments, the reference trajectory of the autonomous vehicle includes a vehicle speed limit associated with the reference trajectory (e.g., the vehicle speed limit can vary over at least one portion of the reference path). In some embodiments, the vehicle speed limit includes at least one of a legal vehicle speed limit, a vehicle capability speed limit, or a user-defined vehicle speed limit. In some embodiments, the maximum speed of the autonomous vehicle is a lesser of the permissible speed of the vehicle speed constraint and the vehicle speed limit.

At block 1606, the control circuit receives the proximity rule (e.g., the proximity rule can be received by the planning module 404 and the combined MPC 1310).

At block 1608, the control circuit determines a predicted trajectory (e.g., predicted trajectory 422) based on the reference trajectory and the proximity rule (e.g., the controller can determine speed and steering commands for the vehicle based on the predicted trajectory). In some embodiments the predicted trajectory includes a number of predictions including a respective predicted position of the autonomous vehicle relative to the obstacle and a respective vehicle speed constraint. In some embodiments, the predicted trajectory is determined at an interval based on at least one of a rate of closure between the autonomous vehicle and the obstacle, a current speed of the autonomous vehicle, a predicted speed of the autonomous vehicle, a difference between the reference trajectory and the predicted trajectory, or a shape of the obstacle.

In some embodiments, the obstacle includes at least one of a vehicle, a pedestrian, debris, or an animal. In some embodiments, the obstacle moves relative to the autonomous vehicle.

At block 1610, the control circuit navigates the autonomous vehicle according to the predicted trajectory (e.g., the controller determines speed and steering commands for the vehicle based on the predicted trajectory). In some embodiments, as part of the navigating the autonomous vehicle, the controller determines a set of steering commands based on the predicted trajectory. In such embodiments, the controller also determines a set of speed commands based on the predicted trajectory. In such embodiments, the controller implements the determined set of steering commands and the determined set of speed commands.

In some embodiments, the controller obtains sensor data generated by a second (e.g., a sensor of the autonomous vehicle). In such embodiments, the sensor data is associated with an obstacle (e.g., detection of the obstacle, state (e.g., position, velocity, acceleration) of the obstacle, classification of the obstacle) proximate one or both of the reference trajectory or the predicted trajectory. In some embodiments, the position of the autonomous vehicle relative to the obstacle includes a lateral clearance of the autonomous vehicle from the obstacle and a longitudinal clearance of the autonomous vehicle from the obstacle.

In some embodiments, in response to one or both of an increase in the lateral clearance of the autonomous vehicle from the obstacle or an increase in the longitudinal clearance of the autonomous vehicle from the obstacle, an increase is made in the permissible speed of the vehicle speed constraint. In some embodiments, in response to one or both of a decrease in the lateral clearance of the autonomous vehicle from the obstacle or a decrease in the longitudinal clearance of the autonomous vehicle from the obstacle, a decrease is made in the permissible speed of the vehicle speed constraint.

In some embodiments, an emergency collision avoidance system is activated in response to a determination that one or both of the sensor data generated by the sensor or the predicted trajectory indicates a collision with the obstacle by the autonomous vehicle (e.g., in response to a determination that the probability that the predicted trajectory will result in a collision with the obstacle exceeds a predetermined threshold).

In the foregoing description, embodiments have been described with reference to numerous specific details that can vary from implementation to implementation. The description and drawings are, accordingly, to be regarded in an illustrative rather than a restrictive sense. The sole and exclusive indicator of the scope of the claims, and what is intended by the applicants to be the scope of the claims, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system, comprising:
at least one computer processor; and
at least one non-transitory storage medium storing instructions which, when executed by the at least one computer processor, cause performance of operations comprising:
while an autonomous vehicle is operating in an autonomous mode:
receiving, using a planning circuit, a proximity rule;
receiving from the planning circuit, using a control circuit, a reference trajectory, wherein the reference trajectory is determined by the planning circuit based on the proximity rule;
receiving, using the control circuit, the proximity rule;
determining, using the control circuit, a predicted trajectory based on the reference trajectory and the proximity rule; and
navigating, using the control circuit, the autonomous vehicle according to the predicted trajectory.

2. The system of claim 1, wherein the instructions, when executed by the at least one computer processor, further cause performance of operations comprising:
obtaining, using the control circuit, sensor data generated by a sensor, the sensor data being associated with an obstacle proximate one or both of the reference trajectory or the predicted trajectory.

3. The system of claim 2, wherein the proximity rule comprises a vehicle speed constraint as a function of at least a position of the autonomous vehicle relative to the obstacle, wherein the vehicle speed constraint defines a permissible speed of the autonomous vehicle based on the position of the autonomous vehicle relative to the obstacle.

4. The system of claim 3, wherein the vehicle speed constraint is a function of the position of the autonomous vehicle relative to the obstacle and at least one of:
a type of the obstacle; or
at least one property of the obstacle.

5. The system of claim 3, wherein the position of the autonomous vehicle relative to the obstacle comprises a lateral clearance of the autonomous vehicle from the obstacle and a longitudinal clearance of the autonomous vehicle from the obstacle.

6. The system of claim 5, wherein, in response to one or both of an increase in the lateral clearance of the autonomous vehicle from the obstacle or an increase in the longitudinal clearance of the autonomous vehicle from the obstacle, the instructions that cause the at least one computer processor to perform the operation of determining the predicted trajectory further cause the at least one computer processor to perform the operation of causing an increase in the permissible speed of the vehicle speed constraint.

7. The system of claim 5, wherein, in response to one or both of a decrease in the lateral clearance of the autonomous vehicle from the obstacle or a decrease in the longitudinal clearance of the autonomous vehicle from the obstacle, the instructions that cause the at least one computer processor to perform the operation of determining the predicted trajectory further cause the at least one computer processor to perform the operation of causing a decrease in the permissible speed of the vehicle speed constraint.

8. The system of claim 2, wherein the reference trajectory comprises a reference path of the autonomous vehicle and at least one vehicle speed constraint of the autonomous vehicle associated with at least one portion of the reference path.

9. The system of claim 8, wherein the reference path of the autonomous vehicle comprises a reference lateral clearance of the autonomous vehicle from the obstacle and a reference longitudinal clearance of the autonomous vehicle from the obstacle for the at least one portion of the reference path.

10. The system of claim 3, wherein the reference trajectory of the autonomous vehicle comprises a vehicle speed limit associated with the reference trajectory.

11. The system of claim 10, wherein the vehicle speed limit comprises at least one of a legal vehicle speed limit, a vehicle capability speed limit, or a user-defined vehicle speed limit.

12. The system of claim 10, wherein a maximum speed of the autonomous vehicle is a lesser of the permissible speed of the vehicle speed constraint and the vehicle speed limit.

13. The system of claim 2, wherein the predicted trajectory comprises a plurality of predictions, comprising:
a respective predicted position of the autonomous vehicle relative to the obstacle; and
a respective predicted vehicle speed constraint.

14. The system of claim 2, wherein the instructions that cause the at least one computer processor to perform the operation of determining the predicted trajectory further cause the at least one computer processor to perform the operation of determining the predicted trajectory at an interval based on at least one of a rate of closure between the autonomous vehicle and the obstacle, a current speed of the autonomous vehicle, a predicted speed of the autonomous vehicle, a difference between the reference trajectory and the predicted trajectory, or a shape of the obstacle.

15. The system of claim 1, wherein the instructions that cause the at least one computer processor to perform the operation of navigating the autonomous vehicle according to the predicted trajectory further cause the at least one computer processor to perform the operations of:
determining, using the control circuit, a set of steering commands based on the predicted trajectory;
determining, using the control circuit, a set of speed commands based on the predicted trajectory; and
implementing, using the control circuit, the set of steering commands and the set of speed commands.

16. The system of claim 2, wherein the obstacle comprises at least one of a vehicle, a pedestrian, debris, or an animal.

17. The system of claim 2, wherein the obstacle is moving relative to the autonomous vehicle.

18. The system of claim 2, wherein the instructions, when executed by the at least one computer processor, further cause performance of operations comprising:
activating an emergency collision avoidance system in response to a determination that one or both of the sensor data generated by the sensor or the predicted trajectory indicates a collision with the obstacle by the autonomous vehicle.

19. A non-transitory computer-readable storage medium storing instructions which, when executed by at least one computer processor, cause performance of operations comprising:
while an autonomous vehicle is operating in an autonomous mode:
receiving, using a planning circuit, a proximity rule;
receiving from the planning circuit, using a control circuit, a reference trajectory, wherein the reference trajectory is determined by the planning circuit based on the proximity rule;
receiving, using the control circuit, the proximity rule;
determining, using the control circuit, a predicted trajectory based on the reference trajectory and the proximity rule; and
navigating, using the control circuit, the autonomous vehicle according to the predicted trajectory.

20. A method performed while an autonomous vehicle is operating in an autonomous mode, the method comprising:
receiving, using a planning circuit, a proximity rule;
receiving from the planning circuit, using a control circuit, a reference trajectory, wherein the reference trajectory is determined by the planning circuit based on the proximity rule;
receiving, using the control circuit, the proximity rule;
determining, using the control circuit, a predicted trajectory based on the reference trajectory and the proximity rule; and
navigating, using the control circuit, the autonomous vehicle according to the predicted trajectory.
